(19) United States
(12) Patent Application Publication
(10) Pub. No.: US 2006/0277098 A1
(43) Pub. Date: Dec. 7, 2006

(54) Media playing system and method for delivering multimedia content with up-to-date and targeted marketing messages over a communication network

(76) Inventors: Tze Dan Chung, West Covina, CA (US); Ying Wai Alex Ip, Foster City, CA (US)

Correspondence Address: Stephen B. Salai, Esq.;Harter, Secrest & Emery LLP, 1600 Bausch & Lomb Place, Rochester, NY, 14604-2711, US

(21) Appl. No.: 11/145,827

(22) Filed: Jun. 6, 2005

(51) Int. Cl. G06Q 30/00

(52) U.S. Cl. 705/14

(57) ABSTRACT

A system and method for delivering multimedia content with up-to-date and dynamically assigned targeted marketing messages over a communication network, and a system that provides a portal for media producers to publish their media contents by delivering media contents with up-to-date and dynamically assigned targeted marketing messages to users over a communication network are disclosed. The invention comprises a media content server, a web server and media player, capable of delivering/playing media contents and marketing messages either on-line or off-line by locally storing media contents and targeted marketing messages.

### FIELD OF THE INVENTION

The present invention relates to a system and method for delivering multimedia content with up-to-date and dynamically assigned targeted marketing messages over a communication network.

### BACKGROUND OF THE INVENTION

The entertainment content providers have been experiencing drastic changes over the past few years, especially in the content distribution value chain. The key driving forces for such changes are rapid evolution and advancement in digital technology. Especially, new audio, video and image compression schemes such as MP3, MPEG4, JPEG, etc., and rollout of broadband internet connection have changed the way to store, reproduce, play and distribute all of these media contents.

These advancements created some problems as well. One of the major problems in entertainment content provider industry is prevalence of piracy in the form of illegally copying music, video, or/and still picture images, and illegally distributing such contents over the Internet. Such distribution of illegally copied digital media contents was made increasingly efficient and cheap by the Peer-to-Peer (P₂P) technologies. This phenomenon has been greatly impacting the movie and music industries.

The industry of entertainment content provider, such as movie and music industries, is now at a critical point, and is being challenged to find or define new and better models or ways to do the business to capitalize their media contents, and to discourage users for piracy, including copying and distributing media contents illegally, while the users are consistently looking for a better and cheaper (or even free) ways to obtain media contents without concerning any legal restrictions.

There have been a number of attempts to address these issues. One of the common solutions is to deliver media contents for free or at a low price by combining advertisement to media content.

US Patent Application Publication No. US 2003/0014310 by Jung et al. published on Jan. 16, 2003 has adopted a method of providing multimedia files combined with advertisement over the Internet (Jung's method); however, this solution has a number of drawbacks. One of them is failing to address enforcing the viewer/user to watch the advertisement messages. For example, advertisement contents are fixed at beginning or at the end of the media content file. If the advertisement is too long, the user may not pay much attention or may just skip it; if the advertisement is too short, it may not pay for the media content. Thus, it is very difficult for Jung's method to scale up or down the amount of advertisement to be played in the media content. Furthermore, since the media content file and advertisement content file are merely combined, the user may easily extract just media content portion to eliminate advertisement. Or, the user may just repeatedly play the media content till advertisement counter expires, so that the media player obsoletes and deletes advertisement, thus the user may watch the media content without advertisement. Another drawback of this solution is that, if the user decides not to view the media content for a long time, say six months or so, the content of advertisement may be already obsolete and may not be relevant or meaningful for anyone. In order to avoid such problem, it is required to re-download the same media content file with new marketing message, which would be a waste of time and bandwidth. This would lead to another problem, which is inaccurate billing to advertisers, i.e. the end user may or may not have viewed the advertisement, but advertisers will be charged based on the number of advertisement downloads.

Another problem with Jung's method is immobility of the media content. Media content files are bounded with hardware serial number or operating system serial number to make sure that content file will not be illegally copied over to other users' machine/device. However, this mechanism will create problems for the users who have multiple mobile and computing devices, such as MP3 players, cellar phones, personal digital assistances (or PDAs) and PCs. These users want to transfer files freely between devices for different occasions or between friends. However, Jung's method will prevent the users to do so, and forces the users to re-download the same content over again from the server for every single device that a particular user owns.

The present invention addresses these issues, and provides more effective delivery of marketing message, accurate billing to advertiser, and maintain mobility of media content file while preventing piracy.

### SUMMARY OF THE INVENTION

The present invention relates to a system and method for delivering multimedia content with up-to-date and dynamically assigned targeted marketing messages over a communication network.

According to one aspect of the invention, it provides a media playing system for delivering a multimedia content with up-to-date and dynamically assigned targeted marketing messages to a user over a communication network comprising: (i) a media server for managing media content files, media content profiles, marketing messages, marketing message data profile, end user profiles, and a billing database; (ii) a web server for interfacing with the user for registering and authenticating the user, and facilitating downloading of the media content files and the market messages targeted for the user; and (iii) a client device comprising a media player for playing the media content file while the marketing messages are readily available locally or remotely on the media server over the communication network, wherein the media player automatically schedules lengths of intermissions in playing the media content file for playing the marketing messages based on the marketing message data profiles and the media content profile.

According to the other aspect of the invention, it provides a method for playing a multimedia content with up-to-date and dynamically assigned targeted marketing messages delivered to a user over a communication network comprising the steps of: (i) registering and authenticating the user at a web server; (ii) confirming whether marketing messages targeted for the user is readily available locally on a client device or remotely on a media server over the communication network for a media player to play; (iii) automatically searching and downloading marketing messages targeted for the user through a web server; (iv) automatically scheduling lengths of intermissions for playing the marketing messages along with playing of the media content file based on a marketing message data profiles and a media content profile; and (v) playing the media content file and marketing messages as scheduled in step (iv) while marketing messages are readily available.

According to another aspect of the invention, it provides a system for providing a portal for media content providers to publish their media contents by delivering media contents with up-to-date and dynamically assigned targeted marketing messages to users over a communication network comprising: (i) a media server for managing media content files, media content profiles, marketing messages, marketing message data profile, end user profiles, and a billing database; (ii) a web server for interfacing with the users for registering and authenticating of the users, and for facilitating downloading of the media content files and the market messages targeted for the users; and (iii) a client device comprising a media player for playing the media content file while the marketing messages are readily available locally or remotely on the media server over the communication network, wherein the media player automatically schedules lengths of intermissions for playing the media content file containing the marketing messages based on the marketing message data profiles and the media content profile.

According to yet another aspect of the invention, it provides a media playing system for enabling users to download and exchange media content files freely by ensuring the users to view advertisements by delivering up-to-date and dynamically assigned targeted marketing messages to the users over a communication network comprising: (i) a media server for managing media content files, media content profiles, marketing messages, marketing message data profile, end user profiles, and a billing database; (ii) a web server for interfacing with the users for registering and authenticating of the users, and for facilitating downloading of the media content files and the market messages targeted for the users; and (iii) a client device comprising a media player for playing the media content file while the marketing messages are readily available locally or remotely on the media server over the communication network, wherein the media player automatically schedules lengths of intermissions for playing the media content file containing the marketing messages based on the marketing message data profiles and the media content profile.

### BRIEF DESCRIPTION OF THE DRAWINGS

The invention will now be described in more detail with reference to the accompanying drawings, in which:

FIG. 1 illustrates a high-level system structure of an embodiment of the present invention;

FIG. 2 illustrates an example of End User Profile in the embodiment of the present invention;

FIG. 3 illustrates an example of Media Content Profile in the embodiment of the present invention;

FIG. 4 illustrates an example of Marketing Message Data Profile in the embodiment of the present invention;

FIG. 5 illustrates an example of Media Content File in the embodiment of the present invention;

FIG. 6A and FIG. 6B are flow charts illustrating steps of the Media Player for playing Media Content File by confirming availability of most appropriate marketing messages in this embodiment of the present invention;

FIG. 7 is a flow chart for Marketing Message Search in the embodiment of the present invention;

FIG. 8 illustrates the automatic scheduling of marketing message in the embodiment of the present invention;

FIG. 9 illustrates steps for playing the media content file in the embodiment of the present invention;

FIG. 10 illustrates the steps of Media Content Search in the embodiment of the present invention; and

FIG. 11 illustrates steps for billing advertiser in the embodiment of the present invention.

### DETAILED DESCRIPTION OF THE INVENTION

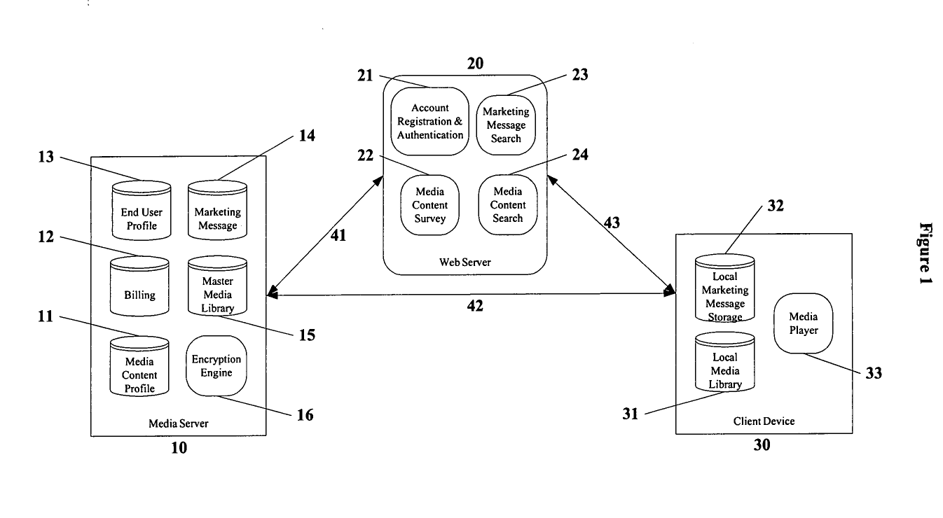

FIG. 1 illustrates a high-level system structure of an embodiment of the present invention, which comprises a Media Server 10, Web Server 20, and Client Device 30. The Media Server 10 comprises a variety of databases, including Media Content Profile database 11, Billing database 12, End User Profile database 13, Marketing Message database 14, and Master Media Library 15. In the actual implementation, these databases can be situated outside the Media Server 10 by connecting them together over a means of communication network. The Media Server 10 may optionally include Encryption Engine 16 for encrypting Media Content Files 160 (not shown). Media Content Profile database 111 stores and manages Media Content Profiles 120 (not shown). Each Media Content File 160 has an associated Media Content Profile 120, which captures profile of the Media Content File 160, which is stored in Master Media Library 15. End User Profile database 13 stores and manages End User Profiles 100 (not shown), which captures information regarding end users (or users), including name, E-mail, address, interest, etc. Marketing message includes, without limitation, an audio, video, image, and text file with URLs. Each marketing message has an associated Marketing Message Data Profile 140 (not shown), which captures profiles of the marketing message. Both marketing messages and Marketing Message Data Profile 140 are stored and managed in Marketing Message database 14.

The Web Server 20 comprises functions of Account Registration and Authentication 21, Media Content Survey 22, Marketing Message Search 23, and Media Content Search 24 for facilitating Media Player 33 to download Media Content Files 160 and marketing messages over a communication network 43. Likewise, the Web Server 20 and the Media Server 10 are connected over a communication network 41. The communication networks 41 and 43 may be a wire line or wireless network. Account Registration and Authentication 21 function manages registration of a user, and generates End User Profile 100 (not shown) by gathering information from the user, such as name, address, gender, password, interest, etc. After the registration, the user will be authenticated based on End User Profile 100. End User Profiles 100 are also used for keeping track of the user interests, geographic location, history of Media Content File 160 downloads, etc. Account Registration and Authentication 21 also manages registration/authentication of advertisers. For example, a registered advertiser, who has once logged in and authenticated, can manage and update their marketing messages through the Web Server 20. Account Registration and Authentication 21 may also enable media content providers to register themselves as media content providers to the system, and to register/upload/manage their media contents to the Media Server 10.

When the user log in to the Web server 20, the Web server 20 also keeps track of IP address of the Client Device 30, where the Client Device 30 could be a computing device, such as a personal computer or a network appliances, or a mobile computing device, such as a laptop computer, mobile phone, portable media player, portable game device, digital video recorder, etc. The Web server 20 validates and determines an approximate geographic location where the user is originally registered based on IP Address History 112 of the End User Profile 100. If the IP address is found to be in different geographic location than it is originally registered, the Web server 20 analyzes and search for the possible approximate geographic location, and updates IP Address History 112 of End User Profile 100. Updated End User Profile 100 would be used for searching appropriate marketing messages in conjunction with Media Content Profile 120 and determine whether the license for the Media Content File 160 (not shown) in that particular geographic location/region is permitted. The Media Content Survey 22 may be an optional function for surveying and analyzing the popularity of Media Content Files 160 based on age group, gender, geographical location, interest, etc, and the results may be fed back to Marketing Message Search 23 for improving the search for more appropriate marketing messages, re-rating premium for billing on certain Media Content Files 160, generating recommendation of Media Content File 160 for a specific user group with a similar user profile, etc. Marketing Message Search 23 is a search engine for searching appropriate marketing messages for a particular user and his/her choice of a Media Content File(s) 160. It generates a search query to the Media Server 10. Marketing messages are searched based on End User Profile 100 (not shown) and Media Content Profile 120 (not shown). In practice, the Web Server 20 may be configured to have a caching mechanism, where frequently accessed marketing messages may reside in the cache on the Web Server 20 for fast query access and off-loading process load from the Media Server 10. This scheme will allow the preferred embodiment of the present invention to be more scalable to grow the number of Web Server 20 to accommodate more users. Alternatively, the Marketing Message Search 23 feature, which may only reside inside the Media Server 10, handles search queries directly from the Media Players 33.

The Client Device 30 comprises the Media Player 33, Local Media Library 31 and Local Marketing Message Storage 32. Local Media Library 31 stores and manages downloaded Media Content Files 160 from Master Media Library 15 on Media Server 10. Local Marketing Message Storage 32 stores and manages marketing messages downloaded from Marketing Message database 14 on Media Server 10. The Media Player 33 may play a downloaded Media Content File 160 in Local Media Library 31, or may play a Media Content File 160 in streaming or progressive downloading fashion while the marketing messages are readily available locally in Local Marketing Message Storage 32 or remotely in Media Server 10 for downloading, progressive downloading or streaming over a communication network 42, including wire line (such as dial-up, cable, xDSL, Ti etc) and wireless (3G, 2.5G, WiFi, etc) network. In other words, the Media Player 33 ensures that marketing messages are readily available for showing to the user. Media Content 162 (not shown) is divided into a plurality of sections, in the similar way as how a DVD is divided into different sections, for inserting intermissions to play marketing messages. These sections are denoted by section pointers, which are stored in the Media Content Header 161 (not shown) of the Media Content File 160. Media Player 33 automatically schedules playing of marketing messages by inserting the messages into intermissions in the playing of Media Content 162. By having both Local Media Library 31 and Local Marketing Message Storage 32, it enables the Media Player 33 to play the Media Content Files 160 on-line or off-line from the communication network 42 or 43 without sacrificing playing marketing messages to the user. It is to be noted that Media Content File 160 and marketing messages can be downloaded, stored and managed separately and independently. This capability with the feature of automatic scheduling of marketing message provides flexibility to deliver most up-to-date and dynamically assigned targeted advertisement to the user. By having only the Media Player 33 being capable of decrypting the encryption of the Media Content File 160, it also allows the users to freely copy and distribute the Media Content Files 160 without losing ways to deliver and to show marketing messages to new users.

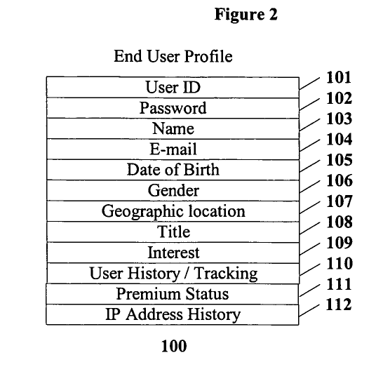

FIG. 2 illustrates an example of End User Profile 100 in this embodiment of the present invention. End User Profile 100 comprises a plurality of fields to store and manage variety of information, including, but not limited to, User ID 101 for user identification/nickname, Password 102 for user password, Name 103 for name of the user, E-mail 104 for e-mail address(es), Date of Birth (or D.O.B) 105, Gender 106 for user's gender, Geographic Location (or Address) 107, Title 108, Interest 109 for general and particular interests in movie, TV, music genres, sports, travel, leisure, etc, and User History/Tracking 110 for Web Server 20 to keep track of user's media download history. This field may optionally be expanded for keeping track of user's viewing history of advertisements. Premium Status 111 may also be included in the End User profile 100, having a plurality of levels indicating the user's subscription level. For example, some of the users who pay extra fee to opt for excluding or skipping intermissions/marketing messages would have higher Premium Status 111 than those who just register for free/basic service. IP Address History 112 is also included in the End User Profile 100. IP Address History 112 keeps track of IP address changes for the Client Device 30 for validating the current user location. IP Address History 112 can be used to verify whether a media content/marketing messages are allowed or meant to be shown for the particular geographical region as well. D.O.B 105 is used to determine up-to-date age group. D.O.B 105, Gender 106, Geographic Location 107, Interest 109 and User History/Tracking 110 can be used singularly or may be combined for the purpose of targeting specific market by this embodiment of the present invention. For example, assuming an advertiser wants to advertise his/her product to males of age group thirties and forties in Eastern part of North America, D.O.B 105, Gender 106 and Geographic Location 107 are examined by the Marketing Message Search 24 to confirm that criteria are matched for his/her marketing message to ensure that his/her marketing message will be delivered to appropriate users in the targeted market. End User Profile 100 is stored and managed in End User Profile database 13 on Media Server 10. The Media Player 33 on Client Device 30 manages a local copy of End User Profile 100 for updating some of the fields, such as User History/Tracking 110. When Media Player 33 is connected to Media Server 10 over the communication network 42, End User Profile 100 on the Media Server 10 would be updated accordingly with the local copy of End User Profile 100. Other than the fields illustrated herein, occupation, ethnical background information (e.g., language/subtitle preference) and/or special needs information (i.e. physical disabilities,) may be defined as additional fields for the End User Profile 100.

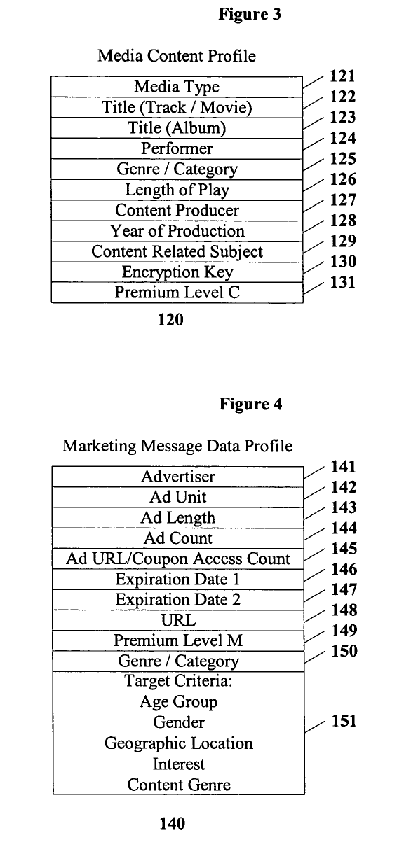

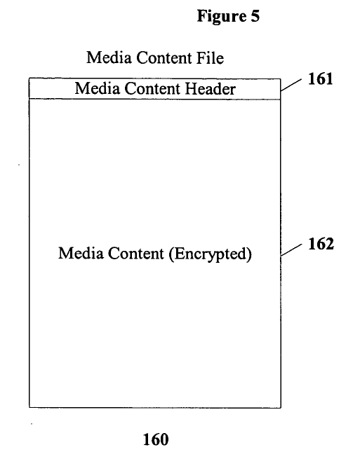

FIG. 3 illustrates an example of Media Content Profile 120 in this embodiment of the present invention. Media Content Profile 120 comprises a plurality of fields to store and manage variety of Media Content related information, including, but not limited to, Media Type 121 indicating type of media, i.e. video, audio, still picture/image, text file with URLs, etc, Title of Movie/Track (movie track/audio track) 122, Title (Album) 123, Performer(s) 124, Genre/Category 125 of Media Content File 160, i.e. for music, it would be jazz, classic, pop, etc, Length of Play 126, Content Producer 127 for name of content producer(s), Year of Production 128, Content Related Subject 129, Encryption Key 130, and Premium Level C 131. Example of Content Related Subject 129 may be that, for James Bond's movies, some of them related to skiing, sports cars, cruise, etc, thus, skiing, sports cars and cruise may be indicated in this field. Content Related Subject 129 can be used to search for appropriate marketing messages conjunction with End User Profile 100. Encryption Key 130 may be optionally used to encrypt/decrypt Media Content File 160. Premium Level C 131 is a field for denoting price level of the Media Content File 160, and has a plurality of levels for different price levels/ranges. Each Media Content File 160 has a certain Premium Level C 131 associated with the price level/range, depending on popularity and other factors. For playing a particular marketing message, the Media Player 33 examines Premium Level M 149 (see FIG. 4) of Marketing Message Data Profile 140 (which indicates premium level of the marketing message) and Premium Level C 131 of Media Content Profile 120 (which indicates premium level of the Media Content File 160) to decide whether to play the marketing message. For example, if the Premium Level M 149 of the Marketing Message Data Profile 140 matches with the Premium Level C 131 of the Media Content Profile 120, the Media Player 33 plays the marketing message. This feature also allows the advertisers to bid a certain level of Premium Level C 131 for their marketing messages to be played on the Media Player 33. Other than the fields illustrated herein, Marketing Message Data Profile 140 may further include popularity ranking status of the media content, and award status if anything awarded (like Grammy awards).

Optionally, the Media Player 33 may maintain and manage Marketing Message's relevance values organizing in a tensor with multi-dimensional indices or a multidimensional array, to facilitate scoring and prioritization in marketing message search. The tensor is organized by having Premium Level C 131 of Media Content Profile 120 and Premium Status 111 of End User Profile 100 among its coordinates (and the other variables in the End User Profiles 100 and the Media Content Profile 120). For example, the more the number of matches between End User Profile 100 and Media Content Profile 120 are, the higher the score will become. The score is also higher when the Premium Level M 149 for the marketing message is high. In addition, it is also possible to artificially increase the values for the marketing message that has an advertising contract expiring soon, so that it would reach the user before its contract expires. Based on the actual Premium Level C 131 of Media Content Profile 120 and Premium Status 111 of the End User Profile 100, the Media Player 33 looks up the marketing message scores for a list of available marketing messages, ranks these scores and decides the priority to play marketing message based on scores for these marketing messages. The higher the score is, the higher the chance is to be played. It is to be noted that the Media Player 33 implements a scheduling algorithm to ensure all of marketing messages have some chance/probability to be played. Such probability is weighted and correlated to the score. Default tensor for the Media Player 33, which is managed and updated in a regular basis at the Media Server 10 based on analyzing collected End User Profile 100 and Marketing Message Data Profile 140, can be downloaded from the Media Server 10 or Web Server 20.

FIG. 4 illustrates an example of Marketing Message Data Profile 140 in this embodiment of the present invention. Marketing Message Data Profile 140 comprises a plurality of fields to store and manage variety of marketing message related information, including, but not limited to, Advertiser 141 for name of advertiser, Ad Unit 142 for total number of times this advertisement will be played to users, Ad Length 143 for duration of advertisement, Ad count 144 for cumulative count of the message being accessed by the Media Player 33 for playing, Ad URL/Coupon Access Count 145 for cumulative count that URL related to the marketing message is being accessed by the user, Expiration Date 1 146 for the date that the marketing message expires, Expiration Date 2 147 for the date that the sales contract for the marketing message with an advertiser expires, URL 148 for URL to advertiser's web site or detail information of the marketing message, Premium Level M 149, Genre/Category 150 for category of marketing message, and Target Criteria 151 including target Age Group, Gender, Geographic Location, Interest, and Content Genre. An advertiser specifies Target Criteria 151 to make sure that his/her marketing message(s) should be delivered to the intended targeted crowds/people/geography/market. The Media Player 33 can obsolete marketing message data when Ad count 144 reaches to the value of Ad Unit 142, or when today's date exceeds either Expiration Date 1 146 or Expiration Date 2 147. The Premium Level M 149 has a plurality of levels associated with the different levels/ranges of prices. The Premium Level M 149 indicates a level/range that the advertiser has paid for the marketing message. It will be used for the marketing message search process as described above.

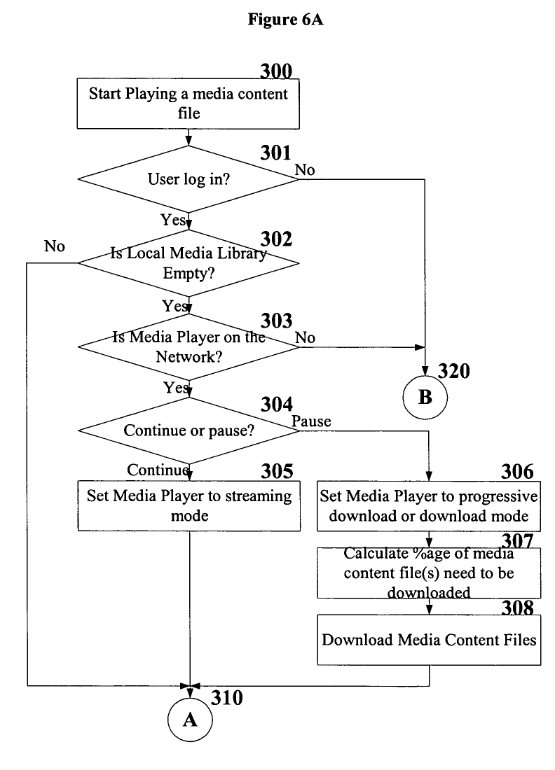

FIG. 5 illustrates an example of Media Content File 160 in this embodiment of the present invention. Media Content File 160 generally includes, but not limited to, two parts, Media Content Header 161 and Media Content 162. Media Content Header 161 includes information regarding file formats of Media Content 162 for reproducing the content. Media Content 162 can be encrypted, and can be decrypted by Encryption Key 130. Public Key Infrastructure may be employed as one of the encryption schemes for securing the media contents. Media Player 33 decrypts encrypted Media Content 162 based on the Encryption Key 130. Media Player 33 is capable of handling many different file formats specified in Media Content Header 161, including, but not limited to, MP3, wma, wmv, MPEG4, wav, gif, JPEG, bitmap, etc.

The Media Player 33 is configured to play the downloaded Media Content File 160 stored in the Local Media Library 31 if the marketing message is readily locally available in Local Marketing Message Storage 32 while the Media Player 33 is off-line or if the marketing message is readily available remotely for downloading, progressive downloading or streaming from the Media Server 10 while the Media Player 33 is on-line. The Media Player 33 is also capable of playing the Media Content File 160 in streaming fashion while the Media Player 33 is on-line, and if the marketing message is readily available locally in Local Marketing Message Storage 32 or if the marketing message is readily available remotely for downloading, progressive downloading or streaming from the Media Server 10. In other words, the Media Player 33 allows itself to play the Media Content File 160 that is readily available locally in Local Media Library 31 or remotely for downloading, progressively downloading or streaming from the Media Server 10 while the marketing messages are readily available locally in the Local Marketing Message Storage 32 or remotely for downloading, progressively downloading or streaming from the Media Server 10 through the communication network connection 42. The Media Player 33 can be configured to play the marketing messages by downloading, progressive downloading, or streaming, based on the user's preference or depending on the condition of communication network.

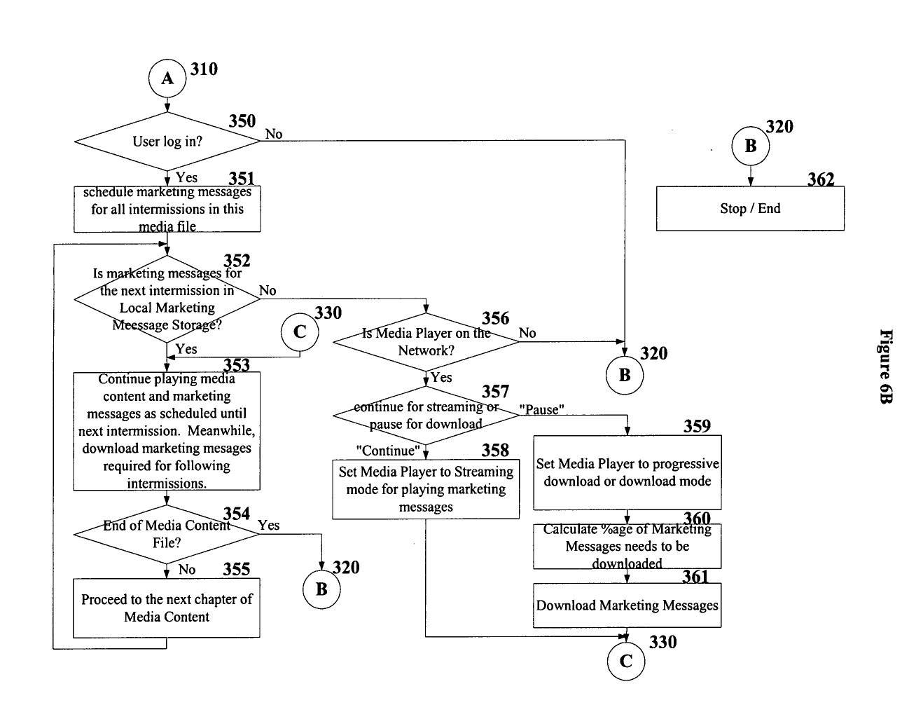

It is important to provide a method/system to ensure the users to view (or likely to view) marketing messages. FIG. 6A and FIG. 6B are flow charts illustrating steps of the Media Player 33 (not shown) for playing Media Content File 160 by confirming availability of the appropriate marketing messages in this embodiment of the present invention. FIG. 6A illustrates the steps confirming availability/acquisition of the media content, whereas FIG. 6B illustrates the steps concerning confirming availability/acquisition of the marketing messages. In FIG. 6A, once the Media Player 33 is about to start playing a Media Content File 160 at step 300, the Media Player 33 checks to see whether the User is logged in or not at step 301. If the user is logged in, then the Media Player 33 proceeds to step 302 to check whether Local Media Library 31 (not shown) is empty; otherwise, the Media Player 33 proceeds to step 320 to continue to steps in FIG. 6B. At the step 302, if the Local Media Library 31 is not empty, it proceeds to step 310 to continue steps in FIG. 6B; if the Local Media Library 31 is empty, it proceeds to step 303 to check whether the Media Player 33 is connected to Media Server 10 or Web Server 20 through the communication network 42 or 43, respectively. If connected, it proceeds to step 304 for confirming whether the Media Player 33 will continue to play the Media Content Files 160 in streaming or pause to progressively download or download the Media Content Files 160; otherwise it proceeds to step 320 to continue steps in FIG. 6B. The decision at 304 may be made by consulting/asking the user through the Media Player 33, by the user configuring the Media Player 33, by the system provider predetermining the option/setting, or by the Media Player 33 automatically deciding the option depending on the condition of the communication network 42/43. If “continue” is selected at step 304, the Media Player 33 configures itself to play Media Content Files 160 in streaming mode at step 305, and then proceed to step 310 to continue steps in FIG. 6B; if “pause” is selected at step 304, then, the Media Player 33 configure itself to progressive download/download mode at step 306, calculates the percentage of the Media Content File(s) 160 needed to be downloaded at step 307, so that before the current chapter of the Media Content File 160 is finished the rest of the chapters/the rest of the Media Content Files 160 will be downloaded to the Media Player 33 from the Media Server 10 or Web Server 20 at step 308. Then, the Media Player 33 proceeds to step 310 to continue steps in FIG. 6B. It is to be noted that Media Content Files 160 are searched by Media Content Search 24 based on the user specified search criteria prior to the downloading of Media Content Files 160 at step 308.

Once the availability of the Media Content Files 160 is confirmed, the Media Player 33 proceeds to the step 310 shown in FIG. 6B. Then, the Media Player 33 checks, again, to see whether the user is log in or not at step 350. If the user is logged in, then the Media Player 33 proceeds to step 351 to schedule marketing messages for all the intermissions in a Media Content File 160 that the Media Player 33 is about to play; if the user is not logged in, then it proceeds to step 320. Once the Media Player 33 automatically schedules the marketing messages at step 351, then the Media Player 33 checks whether there are marketing messages for the next intermission in Local Marketing Message Storage 32 at step 352. If there is no marketing message available for the next intermission, then the Media Player 33 proceeds to step 356; otherwise, it proceeds to step 353. At step 356, the Media Player checks whether it is connected to the Media Server 10 or Web Server 20 over the communication network 42 or 43, respectively. If the Media Player 33 is connected, it proceeds to step 357; otherwise, it proceeds to step 320. At step 357, the Media Player 33 confirms whether the Media Player 33 will continue to play marketing messages in streaming mode or pause to progressively download or download marketing messages for playing them. If “continue” is selected at step 357, the Media Player 33 configures itself to streaming mode for playing marketing messages at step 358, then proceeds through step 330 to step 353; if “pause” is selected, the Media Player 33 configures itself to progressively download/download marketing messages at step 359, calculates the percentage of marketing messages that needs to be downloaded at step 360 so that the marketing messages scheduled to be played at step 351 will be downloaded in sequence. The Media Player 33 ensures that there will always be a sufficient number of marketing messages downloaded and ready prior to the coming intermission, while the Media Player 33 continues to download the rest of the Marketing Messages for the following intermissions. Then, the Media Player 33 downloads marketing messages at step 361, and then proceeds through step 330 to step 353. It is to be noted that the decision at 357 may be made by consulting/asking the user through the Media Player 33, by the user configuring the Media Player 33, by the system provider predetermining the option/setting, or by the Media Player 33 automatically deciding the option depending on the condition of the communication network 42/43. It is also to be noted that marketing messages are searched by Marketing Message Search 23 based on search criteria prior to streaming of marketing messages or prior to progressive downloading/downloading of marketing messages. At step 353, the Media Player 33 continues to play the Media Content File 160 and marketing messages as scheduled at step 351 until the next intermission. While the Media Player 33 is playing the Media Content File 160, the Media Player 33 simultaneously downloads marketing messages required for the following intermission(s). Once the Media Player 33 completes playing the chapter of the Media Content File 160 and marketing messages for the intermission, it proceeds to the step 354 to check whether the end of Media Content File 160 is reached. If it is the end of the Media Content File 160, it proceeds through step 320 to step 362; if it is not the end of the Media Content File 160, it will proceed back to step 352 aforementioned and continue to play the next chapter of the Media Content File 160. At step 362, the Media Player 33 stops playing the Media Content File 160 and marketing messages.

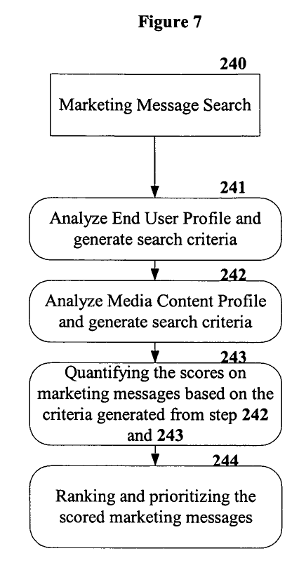

Upon request from the Media Player 33, Web Server 20 performs Marketing Message Search 240 as shown in FIG. 7. The Web Server 20 analyzes the End User Profile 100 at step 241, including, but not limited to, user's age group based on Date of Birth 105, Gender 106, Geographic Location 107, Interest 109 and User History/Tracking 110, and generates search criteria. User History/Tracking 110 may be used to confirm whether user interest has been changed recently. Then, at step 242, the Web Server 20 analyzes Media Content Profile 120, extract information, and generate criteria that may related to or may reflect to the user's interest for finding more suitable and targeted advertisement messages during search. The analysis may include, but not limited to, examining Performer 124, Genre/Category 125, Content Producer 127, and Content Related Subject 129. Based on the Media Content Profile 120 conjunction with User History/Tracking 110 of the End User Profile 100, the Web Server 20 may update Interest 109 for finding more targeted advertisement messages during search. By taking these two steps prior to the actual search, these steps ensure to define most up-to-date advertisement search criteria that suites the user's most recent interest and to improve effectiveness/impression of advertisement. Based on the analysis, the Web Server 20 proceeds to step 243 to quantify relevance of marketing messages based on Marketing Message Data Profiles 140 that matches Target Criteria 151 with the criteria that is generated from step 241 and 242. For example, the more the number of matches in the criteria are, the higher the relevance score of the marketing message will be. Based on the relevance scores, then the Web Server 20 proceeds to step 244 for ranking and prioritizing the scored marketing messages, and decide which and what order the marketing messages are to be played.

The relevant scores of the marketing messages may be calculated as follows. Marketing Message Search 23 maintains and manages two sets of relevance values organized in tensor with multi-dimensional indices or multidimensional array—one tensor having Content Related Subject 129 of Media Content Profile 120 and Interest of Target Criteria 151 of Marketing Message Data Profile 140 as its coordinates, and the other tensor having Interest 109 of End User Profile 100 and Interest of Target Criteria 151 of Marketing Message Data Profile 140 as its coordinate. The Marketing Message Search 23 uses these two sets of relevance values to calculate the relevance score for each marketing message as part of the marketing message search to find the most appropriate and effective marketing messages. Each marketing message will have a unique score at a particular search when a particular user is playing a particular Media Content File 160 at a particular time. Marketing messages that are not relevant (i.e. wrong Premium Level M 149 or wrong Target Criteria 151) will have score equal to zero and be discarded for the particular situation. The scores of all relevant marketing messages are compared and ranked. The probability of a particular marketing message being selected for playing is a function of its score. Marketing messages with the highest scores will have the highest probability to be selected and played with the particular media content.

The Media Server 10 or Web Server 20 maintains and manages these sets of relevance values (i.e. the tensor coordinates aforementioned). By updating these values at the Media Server 10 or Web Server 20, the search results may be tuned or optimized. The updating and revision can be done manually or automatically by analyzing the search results and user's behavior log upon marketing messages based on Ad Count 144 and Ad URL/Coupon Access Count 145 of Marketing Message Data Profile 140. Once the suitable marketing messages are searched and downloaded to the Local Marketing Message Storage 32 (not shown), the Media Player 33 (not shown) automatically schedules playing of the marketing messages once the user requested to play the Media Content File 160.

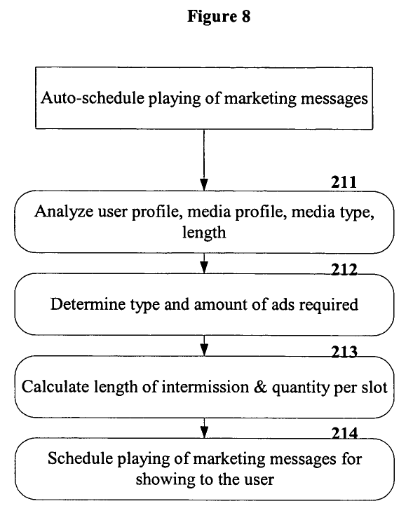

FIG. 8 illustrates this automatic scheduling of marketing message. The Media Player 33 analyzes the End User Profile 100 (not shown), Media Type 121 and Length of Play 126 of the Media Content Profile 120 (not shown) and Marketing Message Data Profile 140 at step 211. This analysis is quite important since Media Content File 160 and marketing messages are downloaded separately, quite possibly, at different time frames, thus the Media Player 33 needs to make sure that marketing messages are, again, align with the user's most current interests and the Media Content File 160. It is also important to confirm that marketing messages are not expired by checking Ad Count 144, Expiration Date 1 146, and Expiration Date 2 147 of Marketing Message Date Profile 140 (not shown). Then, at step 212, the Media Player 33 determines type and amount of marketing messages to be played/required. Based on Ad Length 143 (not shown), Premium Level M 149 (not shown), and Length of Play 126 (not shown), the Media Player 33 calculates length of intermission and quantity per slot in step 213. Then, at step 214, the Media Player 33 schedules playing of marketing messages, i.e. the Media Player 33 decides the length of each intermission, and how many marketing messages or which marketing messages are to be shown in each intermission. Once the Media Player 33 completes scheduling of marketing messages, it will start to play the Media Content File 160 (not shown).

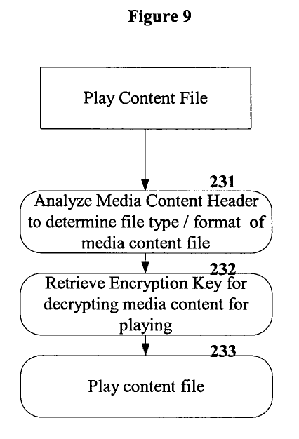

FIG. 9 illustrates the steps for playing the Media Content File 160 in this embodiment of the present invention. Once the Media Player 33 enters the step 353 for playing the Media Content File 160, it analyzes the Media Content Header 161 of the Media Content File 160 to determine the type/format of the Media Content File 160 for activating appropriate decoder at step 231. Once file type/format is analyzed, then at step 232, the Media Player 33 retrieves Encryption Key 130 (not shown) for decrypting the Media Content File 160 for reproducing, and, at step 233, playing the Media Content File 160.

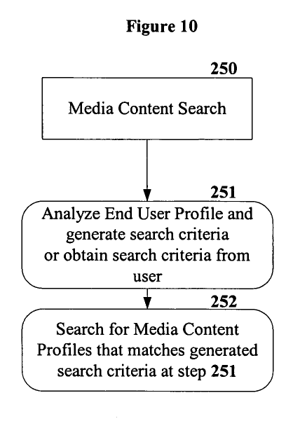

Web Server 20 (not shown) provides Media Content Search feature 24 (not shown) for the users to find Media Content Files 160 that matches name of title, name of performer, name of content producer, etc. It also provides a way to search content by their interests, or something related to the Media Content Files 160 that the user recently downloaded or streamed. This search feature may be requested by the user or automatically run at the Web Server 20 whenever the user accessed the Web Server 20 for searching the Media Content File 160 or downloading a specific Media Content File 160 to suggest related Media Content Files 160 that may be of the user's interest. FIG. 10 illustrates the steps of Media Content Search in this embodiment of the present invention. Once Media Content Search is requested at step 250, it analyzes Interest 109 and User History/Tracking 110 of the End User Profile 100 and generates search criteria or obtains search criteria from the user at step 251. Once search criteria are generated, it searches for Media Content Profiles 120 (not shown) that match the generated criteria at step 252.

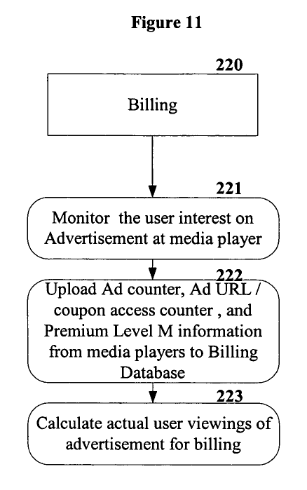

Since this invention provides features to enable flexible macro and targeted marketing messages to the users in real time, it is also possible to provide performance based pricing/billing to advertisers. FIG. 11 illustrates steps for billing advertiser in this embodiment of the present invention. Once billing is activated at step 220, the Media Player 33 monitors the user's interest on advertisement at step 221, i.e. which marketing messages are played to the user and how many times that marketing message related URL are clicked/accessed by the user. Those information are gathered, summarized and updated in Ad Count 144 and Ad URL/Coupon Access Count 145 of Marketing Message Data Profile 140 (not shown). The uploading of Marketing Message Data profile 140 with updated Ad Count 144 and Ad URL/Coupon Access Count 145 to the Billing database 12 of the Media Server 10 (not shown) may be done on a regular basis, i.e. weekly or every time the Media Player 33 is connected to the Media Server 10 over the communication network 42 at step 222. Step 222 also includes the case when the marketing message expires based either on Expiration Date 1 146 or Expiration Date 2 147 of Marketing Message Data Profile 140. For example, while the Media Player 33 is connected to the Media Server 10 through a communication network 42, Marketing Message Data Profile 140 with updated Ad Count 144 and Ad URL/Coupon Access Count 145 is retrieved and uploaded to Billing database 12 of Media Server 10. Once the information are uploaded and gathered in the Billing database 12, actual billing to the advertiser for the advertisement based on user's actual viewing/accessing can be calculated at step 223. These steps are to ensure delivery of the media contents being paid by the advertiser and to enable a service provider to provide variety of media contents to the users for free or at a lowest cost.

Optionally, at step 223 of FIG. 11, the Billing database may also collect End User Profile 100 along with Marketing Message Data Profile 140. By analyzing End User Profile 100 and Marketing Message Data Profile 140, statistics of who, in terms of gender, age group, geographical location, interest, etc, are more likely to be interested in the marketing message can be generated. This statistical data can be reported to the advertiser for future improvement, or can also be used for automatically optimizing and adjusting target market by updating Target Criteria 151, for example, it may be used to determine, update or optimize the relevance values tensor used in Marketing Message Search 204 and Ranking/Prioritization Process of step 244 in FIG. 7.

It is to be noted that billing calculation can be done on media content file basis (media content by media content), or media provider/producer base with conjunction with uploading the End User Profiles 100 from Media Players 33 and analyzing User History/Tracking 110. This flexibility allows the aforementioned embodiment of the present invention to be a platform/portal for publishing media contents produced by individual media producers.

It is to be understood that the embodiments and variations shown and described herein are merely illustrations of the principles of this invention and that various modifications may be implemented by those skilled in the art without departing from the spirit and scope of the invention.

What is claimed is:

1. A media playing system for delivering a multimedia content with up-to-date and dynamically assigned targeted marketing messages to users over a communication network comprising:
(a) a media server for managing media content files, media content profiles, marketing messages, marketing message data profile, end user profiles, and a billing database;
(b) a web server for interfacing with said users for registering and authenticating said users, and for facilitating downloading of said media content files and said market messages targeted for said users; and
(c) a client device comprising a media player for playing said media content file while said marketing messages are readily available locally or remotely on said media server over said communication network, wherein said media player automatically schedules lengths of intermissions for playing said media content file containing said marketing messages based on said marketing message data profiles and said media content profile.

2. The system as recited in claim 1, wherein said client device further comprises:
(a) a local marketing message storage for storing marketing messages; and
(b) a local media library for storing media content files.

3. The system as recited in claim 2, wherein said client device is a mobile computing device or computing device, wherein said mobile computing device is a laptop computer, personal digital assistant (or PDA), cellar phone, or portable media player, and wherein said computing device is a personal computer or network appliance.

4. The system as recited in claim 1, wherein said web server is further configured to register and authenticate advertisers, and media content providers, wherein said advertisers are granted to upload and manage said marketing messages to said media server, and said media content providers are granted to upload and manage said media content files in said media server.

5. The system as recited in claim 1, wherein said web server is configured to perform search and prioritization for marketing messages targeted for said users based on a search criteria and said marketing message data profiles.

6. The system as recited in claim 5, wherein said search comprises the steps of:
(a) scoring all said marketing messages with scores based on said marketing message data profiles and said search criteria, wherein said criteria of said search is generated based on said end user profile and said media content profile; and
(b) ranking said marketing messages based on said scores, wherein said marketing messages that have higher values of said score would be ranked higher in probability for playing to said user.

7. The system as recited in claim 6, wherein said score is calculated based on a tensor of relevance values having said marketing message data profile and said search criteria being coordinates of said tensor.

8. The system as recited in claim 6, wherein said end user profile is associated with said user, wherein said end user profile comprises a plurality of fields for maintaining profile information regarding said associated user, wherein said plurality of fields for said end user profile comprises user ID, user password, name, e-mail address, date of birth, gender of said user, geographic location, title, interest, user history and tracking on media contents and marketing messages, a premium status and IP address history.

9. The system as recited in claim 8, wherein said IP address history is updated by said web server monitoring changes in IP address of said client device for keeping track of and updating said geographic location of said end user profile.

10. The system as recited in claim 8, wherein said premium status comprises a plurality of levels associated with a level of subscription of said user.

11. The system as recited in claim 10, wherein said premium status is used by said media player for determining whether to skip playing said marketing messages in intermissions while playing said media content file.

12. The system as recited in claim 6, wherein said media content profile is associated with said media content file, and comprises a plurality of fields for maintaining profile information regarding said associated media content file, wherein said plurality of fields for said media content profile comprises media type, title for track or movie, title for album, name of performer, genre or category, length of play, name of content producer, year of production, content related subject, encryption key for decrypting an encrypted media content, and premium level of said media content file.

13. The system as recited in claim 6, wherein said marketing message data profile is associated with said marketing message, wherein said marketing message data profile comprises a plurality of fields for maintaining profile information regarding said associated marketing message, wherein said plurality of fields for said marketing message data profile comprises name of advertiser, advertisement unit for indicating number of times said marketing message to be played to said user, advertisement length, advertisement count for counting how many times said marketing message has been played, advertisement URL/coupon access count for counting how many times said user accessed URL or coupon, expiration date for said marketing message, expiration date for contract with said advertiser, URL for said advertiser's home page, premium level of said marketing message of said advertiser, genre or category of advertisement, and target criteria for specifying a specific market for said marketing message.

14. The system as recited in claim 1, wherein said media content file comprises a media content header field and a media content field, wherein said media content header field comprises file format, size, and section pointers, and wherein said media content field comprises media content in said file format.

15. The system as recited in claim 14, wherein said media content is an audio, video, image or text file with URL links.

16. The system as recited in claim 14, wherein said media content is divided into a plurality of sections, wherein said sections pointers of media content header field points to each of said sections of media content.

17. The system as recited in claim 14, wherein said media content is encrypted using said encryption key in said media content profile.

18. The system as recited in claim 1, wherein said marketing message is an audio, video, image and text file with URL links.

19. The system as recited in claim 13, wherein said advertisement count and said advertisement URL/coupon access count of said marketing message data profile are updated by said media player accordingly to said user's interaction with said associated marketing message.

20. The system as recited in claim 19, wherein said updated marketing message data profiles are gathered from said media players to said media server for billing to said advertiser of said marketing message once associated marketing message expires according to expiration date for said marketing message or said expiration date for contract with said advertiser of said marketing message data profile.

21. The system as recited in claim 20, wherein said marketing message data profiles are gathered with associated end user profiles from said media players of said users to said media server for automatically optimizing said marketing message search by statistically analyzing said marketing data profiles and said end user profiles.

22. The system as recited in claim 19, wherein said advertisement count, said expiration date for said marketing message or said expiration date for said contract with said advertiser is used by said media player to obsolete said marketing message data associated therewith, wherein said media player obsoletes said marketing message when said advertisement count reaches to the value specified in said advertisement unit field of said marketing message data profile for said marketing message or when today's date exceeds said expiration date for said marketing message or said expiration date for contract with said advertiser of said marketing message data profile for said marketing message.

23. The system as recited in claim 1, wherein said media player is capable of playing media content file in downloading, progressively downloading and streaming fashion.

24. The system as recited in claim 1, wherein said media player is capable of playing marketing messages in downloading, progressively downloading and streaming fashion.

25. The system as recited in claim 1, wherein said web server is configured to generate recommendation of said media content file to said user by surveying popularity of said media content file and analyzing said popularity based on said end user profiles.

26. The system as recited in claim 1, wherein said communication network is a wire line network or wireless network or both.

27. A method for playing a multimedia content with up-to-date and dynamically assigned targeted marketing messages delivered to a user over a communication network comprising the steps of:
(a) registering and authenticating said user at a web server;
(b) confirming whether marketing messages targeted for said user are readily available locally on a client device or remotely on a media server over said communication network for a media player to play;
(c) automatically searching and downloading marketing messages targeted for said user through a web server;
(d) automatically scheduling lengths of intermissions for playing said marketing messages along with playing of said media content file based on a marketing message data profiles and a media content profile; and
(e) playing said media content file and marketing messages as scheduled in said step (d) while marketing messages are readily available.

28. The method as recited in claim 27, wherein said client device further comprises:
(a) A local marketing message storage for storing marketing messages; and
(b) A local media library for storing media content files.

29. The method as recited in claim 28, wherein said client device is a mobile computing device or computing device, wherein said mobile computing device is a laptop computer, personal digital assistant (or PDA), cellar phone, or portable media player, and wherein said computing device is a personal computer or network appliance.

30. The method as recited in claim 27, wherein said web server is further configured to register and authenticate advertisers and media content providers, wherein said advertisers are granted to upload and manage said marketing messages to said media server, and wherein said media content providers are granted to upload and manage said media content files in said media server.

31. The method as recited in claim 27, wherein said searching comprises the steps of:
(a) scoring all said marketing messages with scores based on said marketing message data profiles and a search criteria, wherein said search criteria is generated based on said end user profile and said media content profile; and
(b) ranking said marketing messages based on said scores, wherein said marketing messages that have higher values of said score would be ranked higher in probability for playing to said user.

32. The method as recited in claim 31, wherein said score is calculated based on a tensor of relevance values having said marketing message data profile and said search criteria being coordinates of said tensor.

33. The method as recited in claim 31, wherein said end user profile comprises a plurality of fields for maintaining profile information regarding said associated user, wherein said plurality of fields for said end user profile comprises user ID, user password, name, e-mail address, date of birth, gender of said user, geographic location, title, interest, user history and tracking on media contents and marketing messages, a Premium Status, and IP address history.

34. The method as recited in claim 33, wherein said IP address history is updated by said web server monitoring changes in IP address of said client device for keeping track of and updating said geographic location of said end user profile.

35. The method as recited in claim 33, wherein said premium status comprises a plurality of levels associated with a level of subscription of said user.

36. The method as recited in claim 31, wherein said media content profile comprises a plurality of fields for maintaining profile information regarding said associated media content file, wherein said plurality of fields for said media content profile comprises media type, title for track or movie, title for album, name of performer, genre or category, length of play, name of content producer, year of production, content related subject, encryption key for decrypting an encrypted media content, and premium level of said media content file.

37. The method as recited in claim 36, wherein said premium status is used by said media player for determining to skip playing said marketing messages in intermissions while playing said media content file.

38. The method as recited in claim 31, wherein said marketing message data profile comprises a plurality of fields for maintaining profile information regarding said associated marketing message, wherein said plurality of fields for said marketing message data profile comprises name of advertiser, advertisement unit for indicating number of times said marketing message to be played to said user, advertisement length, advertisement count for counting how many times said marketing message has been played, advertisement URL/coupon access count for counting how many times said user accessed URL or coupon, expiration date for said marketing message, expiration date for contract with said advertiser, URL for said advertiser's home page, premium level of said marketing message of said advertiser, genre or category of advertisement, and target criteria for specifying a specific market for said marketing message.

39. The method as recited in claim 27, wherein said media content file comprises a media content header field and a media content field, wherein said media content header field includes file format, size, and section pointers, and wherein said media content field comprises media content.

40. The method as recited in claim 39, wherein said media content is an audio, video, image or text file with URL links.

41. The method as recited in claim 39, wherein said media content is divided into a plurality of sections, wherein said sections pointers of media content header field points to each of said sections of media content.

42. The method as recited in claim 39, wherein said media content is encrypted using said encryption key in said media content profile.

43. The method as recited in claim 27, wherein said marketing message is an audio, video, image and text file with URL links.

44. The method as recited in claim 38, wherein said advertisement count and said advertisement URL/coupon access count of said marketing message data profile are updated by said media player accordingly to said user's interaction with said associated marketing message.

45. The method as recited in claim 44, wherein said updated marketing message data profiles are gathered from said media player to said media server for billing to said advertiser of said marketing message once associated marketing message expires according to expiration date for said marketing message or said expiration date for contract with said advertiser of said marketing message data profile.

46. The method as recited in claim 45, wherein said marketing message data profiles may be gathered with associated end user profiles from said media players of said user to said media server for automatically optimizing said marketing search by statistically analyzing said marketing data profiles and said end user profiles.

47. The method as recited in claim 38, wherein said advertisement count, said expiration date for said marketing message or said expiration date for said contract with said advertiser is used by said media player to obsolete said marketing message data associated therewith, wherein said media player obsoletes said marketing message when said advertisement count reaches to the value specified in said advertisement unit field of said marketing message data profile for said marketing message or when today's date exceeds said expiration date for said marketing message or said expiration date for contract with said advertiser of said marketing message data profile for said marketing message.

48. The method as recited in claim 27, wherein said media player is capable of playing media content file in downloading, progressively downloading and streaming fashion.

49. The method as recited in claim 27, wherein said media player is capable of playing marketing messages in downloading, progressively downloading and streaming fashion.

50. The method as recited in claim 27, wherein said web server is configured to survey popularity of said media content file.

51. The method as recited in claim 27, wherein said communication network is a wire line network or wireless network or both.

52. A system for providing a portal for media content providers to publish their media contents by delivering media contents with up-to-date and dynamically assigned targeted marketing messages to users over a communication network comprising:
(a) a media server for managing media content files, media content profiles, marketing messages, marketing message data profile, end user profiles, and a billing database;
(b) a web server for interfacing with said users for registering and authenticating said users, and for facilitating downloading of said media content files and said market messages targeted for said users, and for interfacing with said media content providers for registering and authenticating said media content providers for uploading and managing said media content files; and
(c) a client device comprising a media player for playing said media content file while said marketing messages are readily available locally or remotely on said media server over said communication network, wherein said media player automatically schedules lengths of intermissions for playing said media content file containing said marketing messages based on said marketing message data profiles and said media content profile.

53. A media playing system for enabling users to download and exchange media content files freely by ensuring said users to view advertisement by delivering up-to-date and dynamically assigned targeted marketing messages to said users over a communication network, comprising:
(a) a media server for managing media content files, media content profiles, marketing messages, marketing message data profile, end user profiles, and a billing database;
(b) a web server for interfacing with said users for registering and authenticating of said users, and for facilitating downloading of said media content files and said market messages targeted for said users; and
(c) a client device comprising a media player for playing said media content file that is readily available while said marketing messages are readily available locally or remotely on said media server over said communication network, wherein said media player automatically schedules lengths of intermissions for playing said media content file containing said marketing messages based on said marketing message data profiles and said media content profile.
